(19) United States
(12) Patent Application Publication
(10) Pub. No.: US 2026/0034657 A1
(43) Pub. Date: Feb. 5, 2026

(54) MULTI-PURPOSED TOOL

(71) Applicant: Timothy Scott Stuart, Punta Gorda, FL (US)

(72) Inventor: Timothy Scott Stuart, Punta Gorda, FL (US)

(21) Appl. No.: 18/793,721

(22) Filed: Aug. 2, 2024

(51) Int. Cl. B25F 1/00; F21L 4/00; F21V 33/00

(52) U.S. Cl. CPC B25F 1/006; F21L 4/005; F21V 33/0084

(57) ABSTRACT

A multi-purpose hand tool is disclosed having a generally rectangular solid shape with a central opening for receiving the fingers of a hand of the user, the various sides of the tool functioning as a hammer, hex screw driver, nail remover, bottle opener, square and ruler.

### FIELD OF INVENTION

The present invention related to hand tools, and in particular, a hand tool that functions as a hammer, mallet, nail remover, a hex head screw driver, a bottle opener, a ruler and a square.

### BACKGROUND

A typical hammer consists of a handle and a metal striking head made of metal such as steel, and is used to drive a nail into a relatively softer material. In most cases the relatively softer material is wood, but other materials, such a plastic or even thin metal sheets can be held in place by nails. For purposes of this specification, the description will be described in association with a nail being driven into wood, understanding that the tool may be used with other materials. The handle of a typical hammer is made of wood and provides a lever for swinging the head in an arc so as to apply force to a nail. The head of the hammer has a flat striking surface on one end and has a claw for removing nails at the other end.

A significant disadvantage of the typical hammer is that since the hammer is swung in a large arc, it takes a certain amount of hand eye coordination to hit the head of the nail in a flush manner so as to apply the force from the head of the hammer in a direct line with the axis of the nail and flush with the head of the nail. Appling force at an angle to the head of the nail results in the nail being bent or only partially driven into the wood.

Another disadvantage of the typical hammer is that due to the length of its handle, it is often difficult to use the hammer where there is insufficient space to swing the hammer.

Another disadvantage of the typical hammer, is the difficulty of hitting the head of the nail when the nail is not on a level surface or where the nail is not being driven in a vertical direction, such as when the nail is upside down to the horizon, such as under a cabinet.

Another disadvantage of the typical hammer is that it is difficult to apply the necessary force when there is limited or restricted space above the head of the nail.

There have been hammers in the shape of a cylinder. This type of hammer is grasped by the fingers of the user and the bottom of the cylinder is driven into the head of a nail by an up or down movement of the cylinder by the hand. Such a device does not require the same skill as using a hammer having a handle in order to make a flush hit with the top head of a nail, but it does not apply as much force to the top of the head of the nail due to generating less momentum since there is no lever, and it is not designed for striking the nail by the arcuate motion of the wrist when being used.

Also, in construction jobs, there is a need for many separate tools, including nail removers, squares, hex head screw drivers, tape measure, mallets

### SUMMARY OF THE PRESENT INVENTION

The present invention is a multi-purpose tool having a generally rectangular shape with a central opening for receiving the fingers of the hand of the user, having top and bottom segments and two side segments. One of the side segments is substantially circular with finger indentations and forms a handle to be grasped by the hand of the user with the fingers of the hand of the user in the central opening. The handle is covered by over molded plastic. The other side segment and the bottom segment are flat and consist of steel for striking a nail. There is a 45 degree angled steel covered segment between the steel covered side segment and the bottom steel covered segment for use as a fulcrum when the tool is used for removing nails as shown below. The top segment is flat and is also covered in over molded plastic permitting the top segment to be used as a mallet, as shown below, to strike objects without damaging the object, as would be the case if the object was stricken by steel. The steel side segment includes a depression in the shape of the head of a hex headed screw and a depression in the form of a bottle opener and a two sided nail remover. Along the side of the steel covered segments are markings corresponding to the dimensions of a ruler. A battery operated light is provided in the tool to assist in use of the tool in confined spaces, such as below a sink. In addition, an emergency glass breaking element is provided for emergencies.

A projection is provided below the hand held portion to prevent the bottom of the hand from sliding off the tool and in order to provide additional force from the hand when the tool is in use as a hammer.

In use, the tool is held by the handle in the hand of the user and the steel portions are used to strike the head of a nail by either movement of the wrist or hand of the user. The user can also use the tool to remove nails, to drive or remove a hex headed screw or as a bottle opener. The steel covered side segment and the bottom segment are at 90 degrees to one another so that these steel covered segments can be used as a square.

Further details for the construction of the tool and its uses are set forth below.

### OBJECTS OF THE PRESENT INVENTION

It is an object of the present invention to provide a hammer that is easier to use.

It is yet another object of the present invention to provide an improved device that is more lightweight.

It is yet another object of the present invention to provide an improved hammer that is easier to use in smaller spaces.

It is another object of the present invention is to be able to hit nails that are upside down or sideways;

It is another object of the present invention that saves space by having multiple uses, including a bottle opener, a ruler, a square a hex head screw driver and nail remover and mallet.

It is another object of the present invention to provide a tool that is smaller than the conventional hammer.

These and other objects and advantages of the invention will be apparent from a review of the following specification and drawings.

### BRIEF DESCRIPTION OF THE DRAWINGS

FIG. 1 is top perspective view of the tool.

FIG. 2 is a side view of the tool.

FIG. 3 is an end view of the tool

FIG. 4 is a front view of the tool.

FIG. 5 is a top view of the tool.

FIG. 6 is a perspective view of the internal metal skeleton of the tool.

FIG. 7 is a side view of the internal skeleton of the tool.

FIG. 8 is an end view of the internal skeleton of the tool.

FIG. 9 is a side view of the tool being used as a hammer.

FIG. 10 is a side view of the tool used as a square.

FIG. 11 is a view of the tool removing a nail.

### DETAILED DESCRIPTION OF THE DRAWINGS

The description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and a design described herein but is to be accorded the widest scope consistent with the principles and novel features disclosed herein. The following goes at the end of the current detailed description of the invention Although several embodiments have been described in detail for purposes of illustration, various modifications may be made without departing from the scope and spirit of the present disclosure. Accordingly, the disclosure is not to be limited by the examples presented herein, but is envisioned as encompassing the scope described in the appended claims and the full range of equivalents of the appended claims.

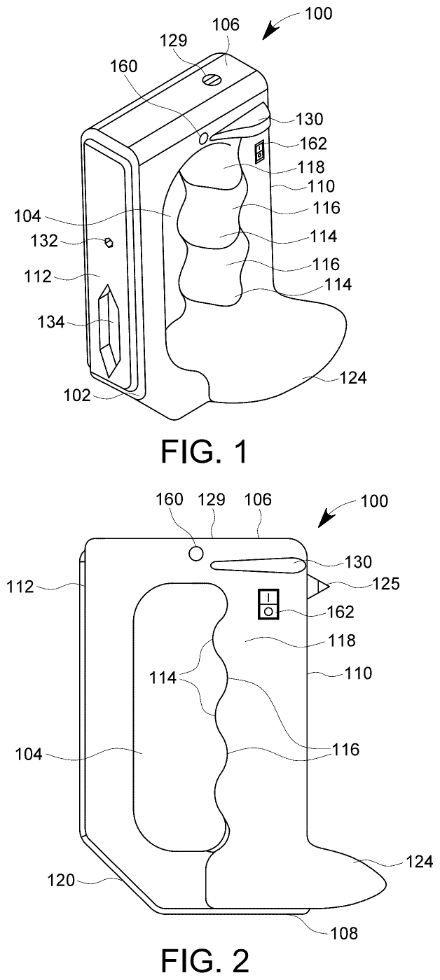

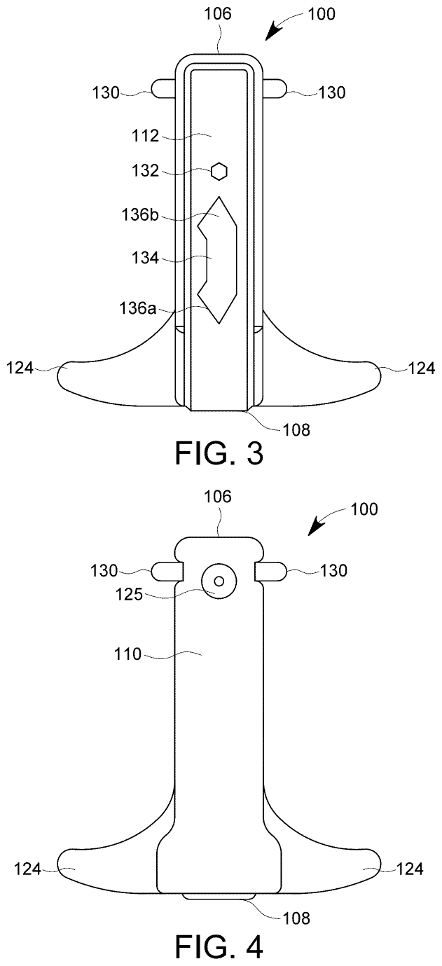

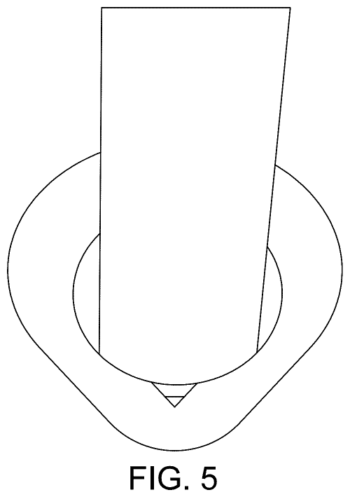

Referring to FIGS. 1-5, the external portion of the tool 100 is shown. The tool 100 consist of a generally rectangular member 102 having an central opening 104 for receiving the fingers of the hand H of the user, with top 106 and bottom 108 segments and first and second side segments 110 and 112. The side segments 110 and 112 are longer than the top 106 and bottom 108 segments.

One of the side segments 110 is substantially circular and has raised 114 and depressed 116 portions to form a handle 118 to be grasped by the hand H of the user with the fingers of the hand H of the user in the central opening 104. The other side segment 112 and the bottom segment 108 are 90 degrees from one another and are flat and consist of steel for striking a nail. There is a 45 degree angled steel segment 120 between the steel segment 120 and the bottom steel segment 108 for striking a nail and for use as a fulcrum when the tool is used for removing a nail, as shown below.

The handle 118 may have roughened portions to prevent slipping of the fingers of the hand H when grasping the handle 118. At the lower end of the handle 118 is a semi-circular arcuate extension 124 and at the upper end of the handle 118 are extensions 130. The extensions 124 and 130 provide support for the upper and lower portions of the hand H of the user when the tool is used as a hammer. The lower extension 124 projects outwardly from the sides and rear at least ½ inch, but in the preferred embodiment is between ¾ and 1 inch, so that the bottom of the hand is supported on the top of the extension 124 when used as a hammer. The extension 124 prevents the bottom of the hand from sliding off of the tool. As the tool is accelerated downwardly in use, the width of the bottom of a hand is approximately at least 1 inch.

The second side segment 112 has an opening 132 in the shape of the head of a hex head screw and of a depth sufficient to receive the head of a hex head screw. The second side segment 112 also has an elongated opening in the form of a bottle opener 134 with the ends 136a and 136b of the bottle opener opening 134 having a narrowed portion for permitting the head of a nail to fit under the narrowed portions 136a and 136b so that the nail can be removed as described below.

A battery operated light 160 is mounted in the top side of the tool. An on/off switch 162 controls the light. The batteries are installed in the interior of the handle with appropriate electrons (not shown). A screw opening 129 is on the top of the tool 100 permitting access for the batteries. A solid steal projection 125 is mounted proximate the top of the end of the tool above the finger grip portion. The steal projection can be used as an emergency glass breaking instrument,

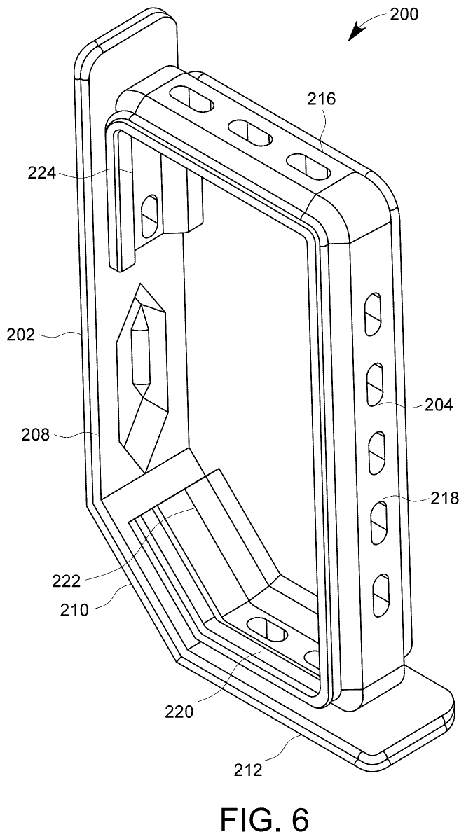

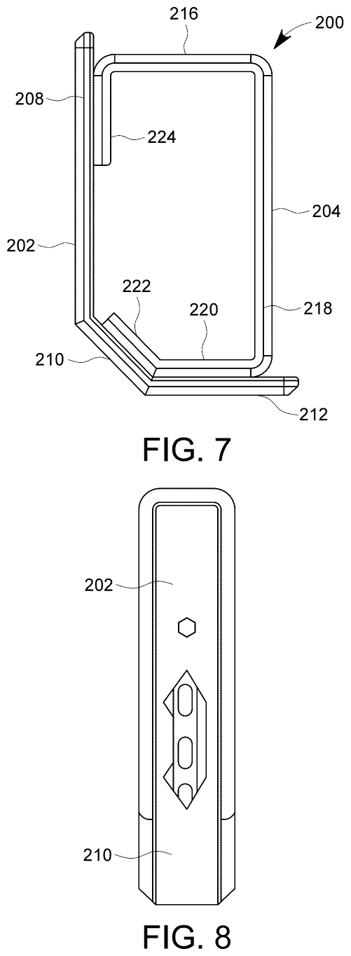

Referring to FIGS. 6-8 the internal construction of the tool 100 is shown. The internal tool 100 includes an internal skeleton 200 formed from a first flat steel member 202 and second steel member 204 that are welded together proximate their ends. The first steel member 202 is generally flat and L-shaped and is referred to as the nail striking member. The nail striking member 206 consists of three segments, a side segment 208, and a 45 degree angled segment 210, and a bottom segment 212. The side segment 208 has openings 132 for the head of a hex head screw and an opening 134 for the nail remover and a bottle opener.

The second of the steel member 204 is flat and generally C-shaped. The C-shaped member consists of 5 segments: a top segment 216, a side segment 218, a bottom segment 220, a bottom angled segment 222 and an upper depending segment 224 for attachment by welding to the inside wall 202 of the L-shaped steel member 202. The C-shaped steel 204 member is slightly smaller in width than the L-shaped steel member 202. The outside wall of the upper depending member 224, the lower angled member 222, and the bottom member 220 are welded to the inside wall of the L-shaped steel member 202 to form the general rectangular member shaped tool having a central opening.

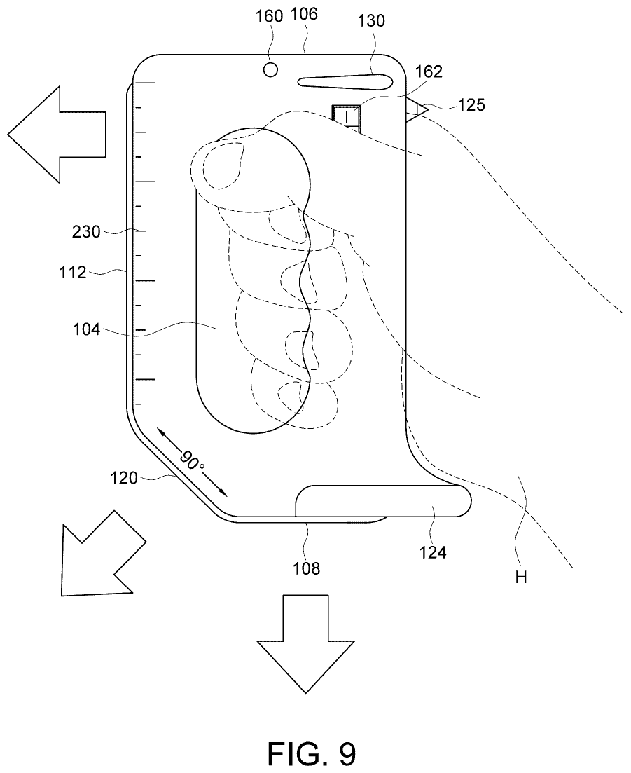

In one embodiment, the entire C-shaped steel member 204 is covered by a plastic material, such as PVC, by a conventional over molding process, with only the side, angled and bottom members being uncovered and leaving a central opening. The over molded plastic forms the handle as described above, having a finger grips portion, an upper and lower arcuate projections. The plastic also forms a widened portion covering the sides of the nail striking members and the top and bottom C-shaped segments forming flat surfaces. As shown in FIG. 9, measuring indicia 230 is formed into the side flat surface along the side of the nail striking surface, for use as a ruler. Inches or centimeters, or both, can be used for the ruler. While the location of the measuring indicia has been described as being positioned proximate the long side of the nail striking segment, it can be placed in other locations as desired.

Referring to FIGS. 9-11, the operation of the tool is shown.

In FIG. 9 the tool is shown being held in the hand, used as a hammer with the side, bottom and angled segment used to strike nails by hitting the nail in the direction shown by the arrows.

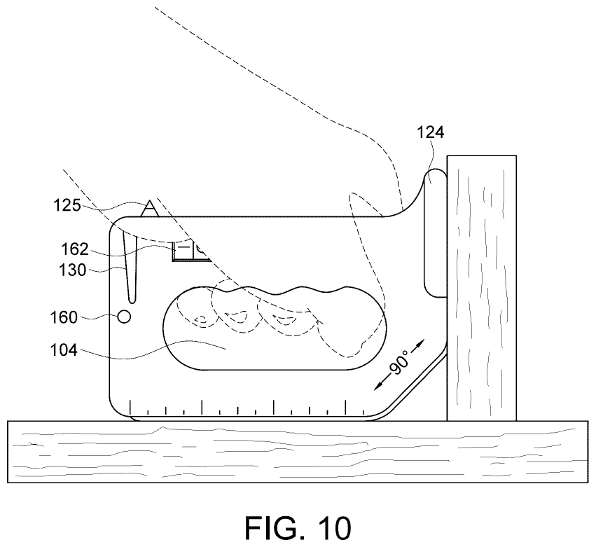

In FIG. 10 the tool is shown as being used as a square.

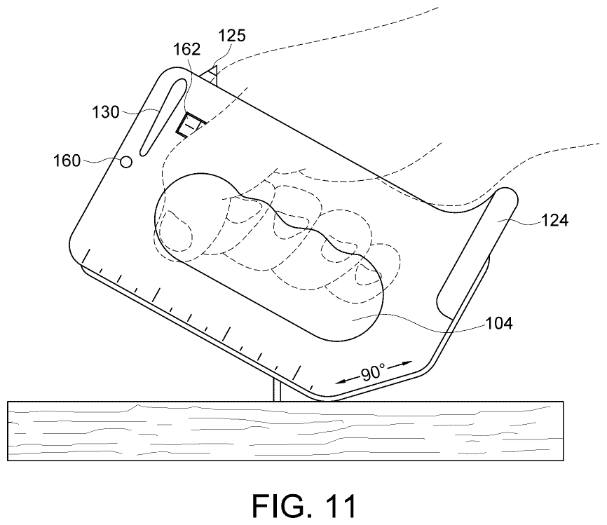

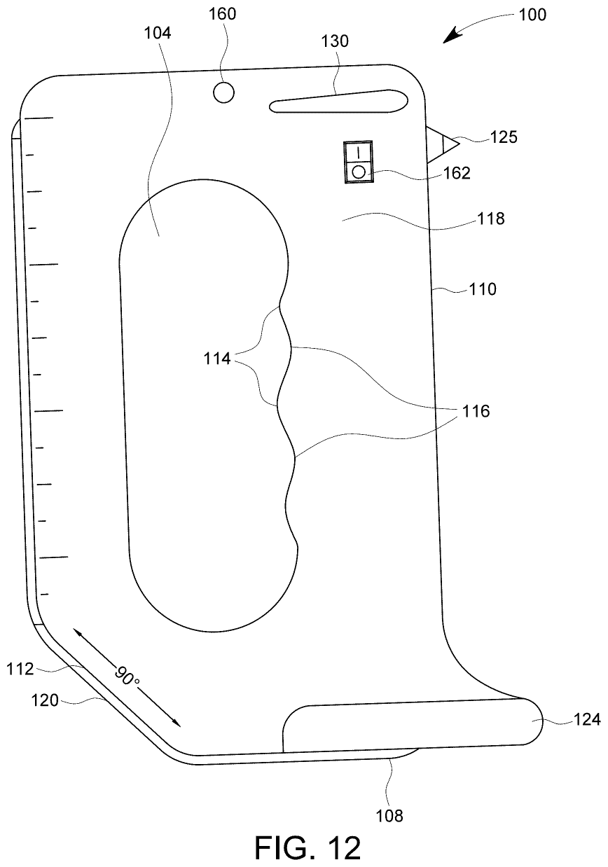

In FIG. 11 the tool is shown used to remove a nail in a piece of wood. The head of the nail is inserted in the steel covered angled segment permits the tool to be rotated in the direction shown by the arrow.

In the preferred embodiment, the tool is about 125 mm high, 75 mm long, and 40 mm thick. The central opening is about 90 mm high and 25 mm wide.

While the preferred and alternative embodiments have been disclosed, other embodiments can be used without departing from the inventive concept disclosed.

The description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein. The following goes at the end of the current detailed description of the invention

Although several embodiments have been described in detail for purposes of illustration, various modifications may be made without departing from the scope and spirit of the present disclosure. Accordingly, the disclosure is not to be limited by the examples presented herein, but is envisioned as encompassing the scope described in the appended claims and the full range of equivalents of the appended claims.

1. A tool comprising a rectangular solid member having a central opening creating four segments including a bottom segment having a flat surface made of metal for hitting a nail and a hand gripping segment adjacent said bottom segment having a projection extending from the bottom of said hand gripping extension from the hand of the user during use of the tool.

2. The tool of claim 1 in which said projection is at least ¾ inches.

3. The tool of claim 2 in which said projection is arcuate.

4. The tool of claim 1 in which said projection is between ¾ inches and 1 inch.

5. The tool of claim 1 in which said tool includes a flashlight.

6. The tool of claim 1 in which said hand gripping segment is hallow for receiving at least one battery for operating said flashlight.

7. The tool of claim 1 in which said tool includes a glass breaking metal member proximate the upper end of said hand gripping segment.
